(19) United States
(12) Patent Application Publication
(10) Pub. No.: US 2025/0308505 A1
(43) Pub. Date: Oct. 2, 2025

(54) Remote ANC System and Operation Method Thereof

(71) Applicants: Hyundai Motor Company, Seoul (KR); Kia Corporation, Seoul (KR); ARE Corp, Daejeon (KR)

(72) Inventors: Chi Sung Oh, Hwaseong-si (KR); Kaang Dok Yee, Yongin-si (KR); Young Taek Lee, Daejeon (KR); Hyoun Suk Kim, Daejeon (KR); Hyuk Wee, Daejeon (KR)

(21) Appl. No.: 18/969,652

(22) Filed: Dec. 5, 2024

(30) Foreign Application Priority Data
Mar. 28, 2024 (KR) 10-2024-0042596

(51) Int. Cl. G10K 11/178; G10L 19/008

(52) U.S. Cl. CPC G10K 11/17854; G10K 11/17881; G10L 19/008; G10K 2210/12821; G10K 2210/3026; G10K 2210/3027; G10K 2210/3028; G10K 2210/3051

(57) ABSTRACT

A method and a device for a remote active noise control (ANC) of a vehicle are provided. The method includes receiving one or more local signals from a vehicle, wherein each local signal includes a reference signal, a noise control signal, an error signal, or a virtual error signal; updating the adaptive filters using the one or more local signals; and transmitting the updated adaptive filter to the vehicle.

### CROSS-REFERENCE TO RELATED APPLICATION

The present application claims priority to Korean Patent Application No. 10-2024-0042596, filed Mar. 28, 2024, the entire contents of which are incorporated herein by reference for all purposes.

### TECHNICAL FIELD

The present disclosure relates to a remote active noise control (ANC) system and an operation method thereof.

### BACKGROUND

The content to be described below simply provides background information related to the present example and does not constitute the related art.

When a vehicle is traveling, noise may occur due to air and structural noise of the vehicle. For example, there may be noise generated by an engine of the vehicle, noise generated by friction between the vehicle and a road surface, vibration transferred through a suspension, wind noise generated by wind, and the like.

Methods of reducing such noise may include a passive noise control method in which a sound absorbing material that absorbs noise is installed inside the vehicle, and an active noise control (ANC) method that uses a noise control signal having an antiphase with respect to the noise.

Since the passive noise control method has limitations in adaptively removing various noises, research on the active noise control method is actively underway. In particular, a road-noise active noise control (RANC) method for removing road noise in a vehicle is attracting attention.

To perform the active noise control, a noise control system of a vehicle may generate a noise control signal having the same amplitude as internal noise of the vehicle, and an antiphase with respect to a phase of the internal noise, and output the noise control signal to the inside of the vehicle, thereby canceling out the internal noise.

There may be limits for a controller included in the vehicle to perform all active noise control due to low performance of the controller.

### SUMMARY

An aspect of the present disclosure is to provide a remote ANC system including a remote server that performs update of an adaptive filter, and a vehicle that generates a noise control signal using the updated adaptive filter, and a method of operating the same.

An aspect of the present disclosure is to provide a data structure allowing loss of data in a packet to be identified in a process of communication between a remote server and a vehicle and allowing non-loss data to be partially utilized, and a method of operating a remote ANC system using the same.

The aspect of the present invention is not limited to the problems mentioned above, and other aspects not mentioned herein will be clearly understood by those skilled in the art from the following description.

A computer-implemented method of updating adaptive filters in a remote active noise control (ANC) system may comprise: receiving one or more local signals from a vehicle, wherein the one or more local signals are associated with noise control by an ANC controller of the vehicle, and wherein each local signal, of the one or more local signals, comprises a reference signal, a noise control signal, an error signal, or a virtual error signal; updating, using the one or more local signals, the adaptive filters of the remote ANC system; and transmitting, to the vehicle, the updated adaptive filter to adjust the ANC controller of the vehicle.

The updated adaptive filters may be associated with a plurality of channels, wherein each of the plurality of channels corresponds to a combination of a reference signal of a respective channel of the plurality of channels and a noise control signal of the respective channel of the plurality of channels. The transmitting the updated adaptive filter may comprise transmitting, via one or more packets, each of the updated adaptive filters. Each of the one or more packets may comprise one or more chunks. Two or more adaptive filters, of the updated adaptive filters, corresponding to different channels may be put in different chunks of a single packet of the one or more packets or put in different packets of the one or more packets.

Each of the one or more chunks may comprise: at least one of coefficients of a respective adaptive filter, of the updated adaptive filters, corresponding to a certain channel of the plurality of channels, and channel information of the certain channel.

The channel information may comprise an identifier assigned to distinguish the certain channel from other channels of the plurality of channels. The channel information may precede the at least one of coefficients of the respective adaptive filter in each respective chunk of the one or more chunks.

Each local signal, of the one or more local signals, may be a multi-channel signal associated with a plurality of channels. The receiving the one or more local signals may comprise: parsing one or more packets received from the vehicle; and extracting, based on the parsed one or more packets, samples for each channel of each local signal of the one or more local signals.

Each of the one or more packets may comprise one or more chunks. Each of the one or more chunks may comprise: at least one of samples corresponding to a combination of a certain local signal of the one or more local signals and a certain channel of the plurality of channels, and channel information of the combination of the certain local signal and the certain channel.

The channel information may comprise an identifier assigned to distinguish the certain local signal from other local signals of the one or more local signals and distinguish the certain channel from other channels of the plurality of channels of the certain local signal. The channel information may precede the at least one of samples in each respective chunk of the one or more chunks.

Each of the one or more packets may further comprise an indication of a data dimension of the one or more chunks. The indication of the data dimension may precede the one or more chunks in each respective packet of the one or more packets.

Each of the one or more packets may further comprise at least one of a time index or ANC control status information. The at least one of the time index or the ANC control status information may precede the indication of the data dimension in each respective packet of the one or more packets.

A method performed in a vehicle associated with a remote active noise control (ANC) system may comprise: transmitting, to a server associated with the ANC system, one or more local signals, wherein the one or more local signals are associated with noise control by an ANC controller of the vehicle, and wherein each local signal, of the one or more local signals, comprises a reference signal, a noise control signal, an error signal, or a virtual error signal; receiving, from the server, adaptive filters of the remote ANC system, wherein the adaptive filters are updated based on the one or more local signals; and generating, by the ANC controller, a noise control signal by applying the received adaptive filters to the reference signal.

Each local signal, of the one or more local signals, may be a multi-channel signal associated with a plurality of channels. The transmitting the one or more local signals may comprise transmitting, to the server via one or more packets, samples for each channel of each local signal of the one or more local signals. Each of the one or more packets may comprise one or more chunks. Two or more samples, of the samples, corresponding to different channels may be put in different chunks of a single packet or put in different packets of the one or more packets.

Each of the one or more chunks may comprise channel information of a combination of a certain local signal of the one or more local signals and a certain channel of the plurality of channels, and wherein at least one of samples corresponds to the combination.

The channel information may comprise an identifier assigned to distinguish the certain local signal from other local signals of the one or more local signals and distinguish the certain channel from other channels of the plurality of channels of the certain local signal. The channel information may precede the at least one of samples in each respective chunk of the one or more chunk.

The received adaptive filters may be associated with a plurality of channels, wherein each of the plurality of channels corresponds to a combination of a reference signal of a respective channel of the plurality of channels and a noise control signal of the respective channel of the plurality of channels. The receiving the adaptive filters may comprise: parsing one or more packets received from the server; and extracting, based on the parsed one or more packets, each of the received adaptive filters corresponding to a respective channel of the plurality of channels.

Each of the one or more packets may comprise one or more chunks. Each of the one or more chunks may comprise: at least one of coefficients of a respective adaptive filter, of the adaptive filters, corresponding to a certain channel of the plurality of channels, and channel information of the certain channel.

The channel information may comprise an identifier assigned to distinguish the certain channel from other channels of the plurality of channels. The channel information may precede the at least one of coefficients of the respective adaptive filter in each respective chunk of the one or more chunks. Each of the one or more packets may further comprise an indication of a data dimension of the one or more chunks. The indication of the data dimension may precede the one or more chunks in each respective packet of the one or more packets.

Each of the one or more packets may further comprises at least one of a time index or ANC control status information. The at least one of the time index or the ANC control status information may precede the indication of the data dimension in each respective packet of the one or more packets.

A device for updating an adaptive filter in a remote active noise control (ANC) system may comprise: a memory storing instructions; and at least one processor configured to execute the instructions to cause the device to: receive one or more local signals from a vehicle, wherein the one or more local signals are associated with noise control by an ANC controller of the vehicle, and wherein each local signal, of the one or more local signals, comprises a reference signal, a noise control signal, an error signal, or a virtual error signal, update, using the one or more local signals, the adaptive filter of the remote ANC system, and transmit, to the vehicle, the updated adaptive filter to adjust the ANC controller of the vehicle. The device may perform one or more additional operations described herein.

A device included in a vehicle in a remote active noise control (ANC) system, the device comprising: a memory storing instructions; and at least one processor configured to execute the instructions to cause the device to transmit, to a server associated with the ANC system, one or more local signals, wherein the one or more local signals are associated with noise control by an ANC controller of the vehicle, and wherein each local signal, of the one or more local signals, comprises a reference signal, a noise control signal, an error signal, or a virtual error signal; receive, from the server, adaptive filters of the remote ANC system, wherein the adaptive filters are updated based on the one or more local signals; and generate, by the ANC controller, a noise control signal by applying the received adaptive filters to the reference signal. The device may perform one or more additional operations described herein.

As described above, according to an example of the present disclosure, it is possible to prevent update delay of the adaptive filter and to improve noise control performance by distributing a noise control algorithm to the vehicle and the server.

According to an example of the present disclosure, it is possible to identify whether data in a packet is lost in a process of communication between a remote server and a vehicle, and to partially utilize non-loss data.

The features of the present disclosure are not limited to the features mentioned above, and other features not mentioned may be clearly understood by those skilled in the art from the description below.

### BRIEF DESCRIPTION OF THE DRAWINGS

FIG. 1 shows an example configuration diagram showing components of a vehicle according to an example of the present disclosure.

FIG. 2 shows an example diagram showing a noise control method according to an example of the present disclosure.

FIG. 3 shows an example of configuration diagram of a noise control algorithm according to an example of the present disclosure.

FIG. 4A and FIG. 4B show examples of diagrams showing a remote active noise control (ANC) system according to various examples of the present disclosure.

FIG. 5 shows an example of configuration diagram of a remote ANC system according to an example of the present disclosure.

FIG. 6 shows an example of flowchart showing a remote ANC method according to an example of the present disclosure.

FIG. 7 shows an example of an illustrative diagram showing a data structure for transmitting and receiving a local signal according to an example of the present disclosure.

FIG. 8 shows an example of an illustrative diagram showing a data structure for transmitting and receiving an adaptive filter according to an example of the present disclosure.

FIG. 9 shows an example flowchart showing an adaptive filter update method according to an example of the present disclosure.

FIG. 10 shows an example flowchart showing a method of generating a noise control signal according to an example of the present disclosure.

### DETAILED DESCRIPTION

Hereinafter, some exemplary examples of the present disclosure will be described in detail with reference to the accompanying drawings. In the following description, like reference numerals preferably designate like elements, although the elements are shown in different drawings. Further, in the following description of some examples, a detailed description of known functions and configurations incorporated therein will be omitted for the purpose of clarity and for brevity.

Additionally, various terms such as first, second, A, B, (a), (b), etc., are used solely to differentiate one component from the other but not to imply or suggest the substances, order, or sequence of the components. Throughout this specification, when a part ‘includes’ or ‘comprises’ a component, the part is meant to further include other components, not to exclude thereof unless specifically stated to the contrary. The terms such as ‘unit’, ‘module’, and the like refer to one or more units for processing at least one function or operation, which may be implemented by hardware, software, or a combination thereof.

The following detailed description, together with the accompanying drawings, is intended to describe exemplary examples of the present disclosure and is not intended to represent the only examples in which the present disclosure may be practiced.

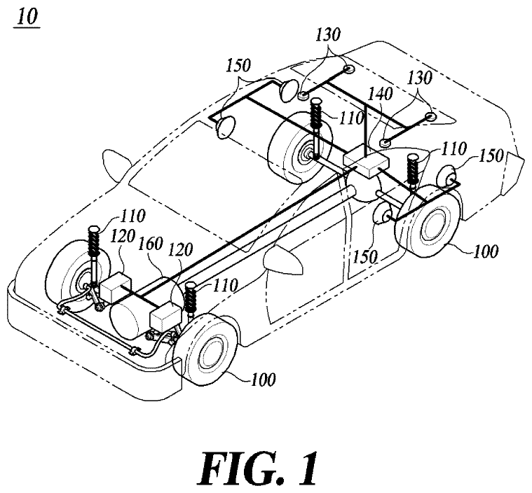

FIG. 1 shows an example configuration diagram showing components of a vehicle according to an example of the present disclosure.

Referring to FIG. 1, a vehicle 10 including wheels 100, suspension devices 110, reference sensors 120, microphones 130, a controller 140, speakers 150, and axle 160 is shown. In FIG. 1, the number and disposition positions of a plurality of components correspond to one example, and the number and positions of the components may vary in other examples.

The vehicle 10 may include a chassis on which accessories necessary for traveling are mounted, and a noise control system that performs active noise control. The vehicle 10 may further include at least one of a powertrain, a steering device, and a braking device.

The chassis of the vehicle 10 includes wheels 100 of the vehicle 10, and the wheels 100 include front wheels disposed on the left and right sides of the front, and rear wheels disposed on the left and right sides of the rear of the vehicle 10. The chassis of the vehicle 10 may further include the axle 160 as a power transmission means, the suspension devices 110 as vibration alleviation means, and a body. The suspension devices 110 may be devices that alleviate vibration or impact of the vehicle 10. For example, while the vehicle 10 is traveling, vibration due to a road surface may be applied to the vehicle 10. The suspension devices 110 may alleviate vibration applied to the vehicle 10 using springs, air suspension, or the like. The suspension devices 110 may improve riding comfort of occupants riding in the vehicle 10 by alleviating the impact.

Noise may be generated inside the vehicle 10 by the suspension devices 110. For example, the suspension devices 110 may alleviate large vibration applied to the vehicle 10, but it may be difficult to eliminate micro vibration caused by friction between the wheels 100 and the road surface. These micro vibrations may generate noise inside the vehicle 10 through the suspension devices 110. For example, noise generated by friction between the wheels 100 and the road surface, noise generated by an engine as a power apparatus, or wind noise generated by wind may flow into the inside of the vehicle 10.

To eliminate noise inside the vehicle 10, the vehicle 10 may include a noise control system. The noise control system of the vehicle 10 may attenuate noise inside the vehicle 10 using the noise control signal having the same amplitude as and an antiphase with respect to a noise signal for the noise inside the vehicle 10.

For example, the noise control system may include the reference sensors 120, the microphones 130, the controller 140, and the speakers 150. The noise control system may further include an amplifier (AMP) for audio playback.

The reference sensors 120 may generate a reference signal representing vibration caused by friction between the wheels 100 and the road surface, and transmit the reference signal to the controller 140. For example, the reference sensors 120 may transmit the reference signal in the form of an analog signal to the controller 140. Additionally or alternatively, the reference sensors 120 may convert the reference signal into a digital signal and transmit the converted digital signal to the controller 140.

The reference sensors 120 may be accelerometers. The accelerometer may be a device that generates an acceleration signal representing an acceleration of the vehicle 10. The accelerometer may be used to measure the vibration of the vehicle 10. For example, the reference sensors 120 may generate reference signals according to the vibration of the vehicle 10, and the reference signals represent acceleration signals. The reference sensors 120 may be three-axis accelerometers and may measure vibration along three vertical axes.

The reference sensors 120 may be disposed on the suspension devices 110, on a connection mechanism that connects the wheels 100 to the axle 160, or on a vehicle body.

The noise control system may use at least one of a gyro sensor, a motion sensor, a displacement sensor, a torque sensor, and a microphone as the reference sensor to measure the vibration of the vehicle 10.

The microphones 130 may detect sound inside the vehicle 10. The microphones 130 may detect noise inside the vehicle 10. For example, the microphones 130 may measure sound pressure at about 20 Hz to 20 kHz that may be an audible frequency band of human. A range of listening frequencies of the microphones 130 may be narrower or wider. For example, the microphones 130 may measure noise flowing into the vehicle 10 due to friction between the wheels 100 and the road surface.

If the noise control signal is output to the inside of the vehicle 10 for noise control, the microphones 130 may measure a noise signal remaining inside the vehicle 10 in an environment in which the noise inside the vehicle 10 may be removed by the noise control signal. The residual noise may be measured as an error signal or residual signal by the microphones 130. The error signal may be used as information for determining whether noise inside the vehicle 10 has been normally reduced or eliminated.

If audio signals are further output to the inside of the vehicle 10, acoustic signals from the microphones 130 may include the error signal and the audio signal.

The controller 140 may generate the noise control signal for removing noise inside the vehicle based on the reference signal of the reference sensors 120 and the error signal. The controller 140 may generate a noise control signal that has the same amplitude as the noise signal but has an antiphase with respect to the noise signal. The controller 140 may convert the reference signal and the error signal, which may be analog signals, into digital signals and generate the noise control signal from the converted digital signals.

If the noise control system includes an amplifier, the amplifier may receive the noise control signal from the controller 140, receive an audio signal from an audio, video, navigation (AVN) device, mix the noise control signal with the audio signal, and output a mixed signal through the speaker.

The amplifier may adjust an amplitude of the mixed signal using amplification circuits. The amplification circuits may include vacuum tubes or transistors for amplifying a power of the mixed signal.

The speakers 150 may receive a mixed signal, which may be an electrical signal, from the amplifier or the noise control signal from the controller 140, and output the mixed signal or noise control signal inside the vehicle 10 in the form of a sound wave. Noise inside the vehicle 10 may be reduced or eliminated by the mixed output of the speakers 150. For example, noise may be reduced as much as possible at the position of the microphones 130 or the ear of the occupant.

The speakers 150 may output the noise control signals only to a specific occupant. For example, the speakers 150 may output different phases of noise control signals at a plurality of positions inside the vehicle 10, causing constructive interference or destructive interference at a position of an ear of a specific occupant.

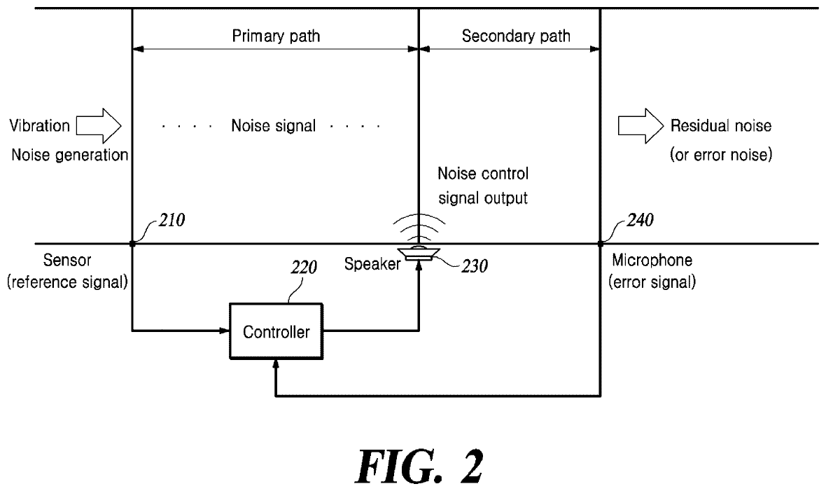

FIG. 2 shows an example diagram showing a noise control method according to an example of the present disclosure.

Referring to FIG. 2, the vehicle noise control system may include a sensor 210, a controller 220, a speaker 230, and a microphone 240.

The noise control system of the vehicle may eliminate noise in the vehicle by outputting the noise control signal generated based on the reference signal from the sensor 210. The noise control signal may be a signal that has the same amplitude as the noise signal, but has an inverse phase to the phase of the noise signal. For example, the noise control system may also remove residual noise inside the vehicle by using the residual noise remaining after noise removal as feedback.

For example, vibration may be generated due to friction between the vehicle and the road surface while the vehicle is traveling, and the generated vibration may cause noise inside the vehicle. The vibration may be measured as an electrical signal by the sensor 210.

The controller 220 may receive the reference signal measured by the sensor 210.

The controller 220 may generate the noise control signal for attenuating the noise inside the vehicle by applying an adaptive filter to the reference signal. For example, the controller 220 may determine filter coefficients of an adaptive filter (e.g., often referred to as a W-filter) based on the error signal(s) and reference signal(s) according to an algorithm such as least mean square (LMS) or filtered-x least mean square (FxLMS) well known in the art. The controller 220 may generate the noise control signal by applying the filter coefficients to the acquired reference signal. The reference signal may become the noise control signal through convolution computation with the filter coefficients.

The controller 220 may output the noise control signal through the speaker 230. If the noise control signal is played through the speaker 230, a sound pressure level of the road noise at the position of the speaker 230 may be reduced.

A path between the sensor 210 and the speaker 230 may be called a primary path or main sound path. The primary path may be a model representing acoustic transfer characteristic from the sensor 210 to the speaker 230.

For example, residual noise may occur at a listening position of the occupant due to a difference in distance between the position of the speaker 230 that may output the noise control signal and the position of the ear of the occupant. For example, because the noise control signal output from the speaker 230 changes while being propagated to the listening position of the occupant, noise may not be completely removed from the position the ear of the occupant. For example, because the noise control signal generated by the controller 220 changes while passing through the amplifier or speaker 230, this may be different from the noise at the listening position of the occupant. This residual noise may be expressed as an error signal representing a difference between the noise signal and the changed noise control signal at the listening position of the occupant.

In order to remove the residual noise, the noise control system may include a microphone 240 near the position of the ear of the occupant and may estimate that a signal measured by the microphone 240 is the residual noise. For example, a path between the speaker 230 and the microphone 240 may be called a secondary path. The noise control system may store a transfer function for the secondary path between the speaker 230 and the microphone 240 in advance.

The controller 220 may receive the error signal fed back from the microphone 240 and update the filter coefficients of the adaptive filter using acoustic transfer characteristic of the secondary path, the reference signal, and/or the error signal. The controller 220 may generate a noise control signal by applying the updated coefficients of the adaptive filter to the reference signal. The noise control signal may have an ideal waveform so that, if the noise control signal is played by the speaker 250 via an amplifier, an offset sound having a substantial antiphase with respect to and the same size as road noise heard by the occupant in the vehicle cabin may be generated at a place close to the microphone 240. An offset sound from the speaker 230 may meet the road noise near the microphone 240 in the vehicle cabin so that a sound pressure level caused by the road noise may be lowered at this position. For example, the noise control signal based on the secondary path may reduce noise and residual noise at the position of the microphone 240. If the microphone 240 is closer to a listening position of the occupant, the microphone 240 may measure noise closer to the residual noise at the listening position of the occupant. If the microphone 240 is disposed at a place close to the position of the ear of the occupant, this may be advantageous to remove the residual noise.

The noise control system of the vehicle may more accurately model the secondary path using a virtual microphone. The controller 220 may generate a virtual microphone at the position of the ear of the occupant, and acquire accurate information for acoustic transfer characteristic between the speaker 230 and the listening position of the occupant based on the signal measured by the virtual microphone. The secondary path may include a path between the speaker 230 and the microphone 240 and a path between the microphone 240 and the virtual microphone.

Through the above process, the noise control system of the vehicle may further attenuate residual noise at the position of the ear of the occupant, and the performance of active noise control may be improved.

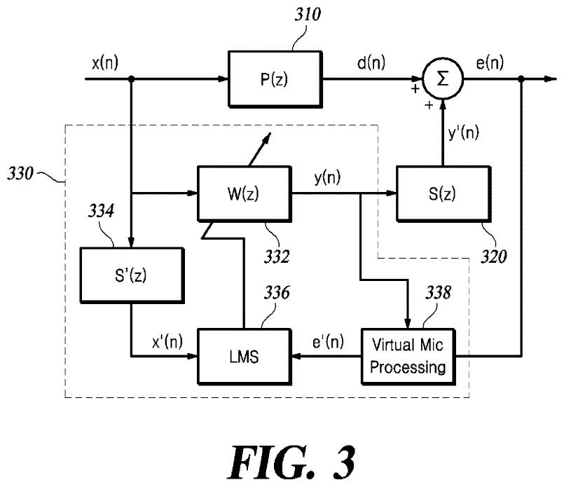

FIG. 3 shows an example configuration diagram of a noise control algorithm according to an example of the present disclosure.

Referring to FIG. 3, a primary path 310, a secondary path 320, a controller 330, an adaptive filter 332, a secondary path model 334, an adaptive filter controller 336, and a virtual error signal estimator 338 are shown. The controller 330 may be a device included in the vehicle.

The noise control algorithm shown in FIG. 3 may relate to a single-channel feedforward Filtered-input Least Mean Square (FxLMS) algorithm. For example, a single-channel feedforward FxLMS algorithm may comprise an adaptive signal processing technique that may be used in ANC systems. The single-channel feedforward FxLMS algorithm may generate an anti-noise signal to counteract unwanted noise in real-time. The single-channel feedforward FxLMS algorithm may use a reference signal from a sensor (e.g., located near the noise source) to predict the noise before it reaches a listener.

Additionally or alternatively, multi-channel structures with many additional channels, many additional microphones, and many additional speakers may also be employed and algorithms for the same may be employed. For example, 12 acceleration sensors and 8 speakers may be used, and a total of 12×8 sets of filter coefficients may be used for the algorithm. Each filter coefficient set includes at least one filter coefficient. Hereinafter, a noise control algorithm based on one sensor and one speaker may be described. For example, n represents a sampling time and z represents a frequency.

A reference signal x(n) may be sensed by the reference sensor of the vehicle. For example, the reference signal x(n) may be a measurement signal of an accelerometer or a vibration sensor. The reference signal x(n) may become the noise signal d(n) through the primary path 310. The primary path 310 may represent a path between the reference sensor and speaker. The acoustic transfer characteristic P(z) of the primary path 310 may refer to a relationship between the reference signal x(n) and the noise signal d(n). The noise signal d(n) may be noise at a position where the controller 330 wants to control. For example, the noise signal d(n) may represent noise at the position of the ear of the occupant.

The controller 330 may generate the noise control signal y(n) for removing the noise signal d(n) using an adaptive control algorithm. The noise control signal y(n) may be a signal for removing or attenuating the noise signal d(n).

As the adaptive control algorithms, the controller 330 may use various algorithms such as Filtered-input Least Mean Square (FxLMS), Filtered-input Normalized Least Mean Square (FxNLMS), Filtered-input Recursive Least Square (FxRLS), and Filtered-input Normalized Recursive Least Square (FxNRLS).

For example, Filtered-input Normalized Least Mean Square (FxNLMS) may comprise an enhancement of the FxLMS algorithm that may be used in adaptive noise control and signal processing. FxNLMS may normalize the step size in the adaptation process to ensure stability and faster convergence, for example, if dealing with signals that vary in amplitude. By taking the power of the input signal into account, FxNLMS may dynamically adjust the filter's coefficients more effectively than standard FxLMS, resulting in improved noise cancellation performance. This normalization process may make the algorithm less sensitive to variations in signal strength, making it a robust choice for environments where the noise levels may fluctuate.

For example, Filtered-input Recursive Least Square (FxRLS) may comprise an advanced adaptive filtering algorithm that may provide faster convergence rates and better tracking capabilities compared to FxLMS and FxNLMS. FxRLS may use a recursive method to minimize the error between the desired and actual output by continuously updating the filter coefficients with a focus on minimizing the sum of the squares of past errors.

For example, Filtered-input Normalized Recursive Least Square (FxNRLS) may combine the advantages of both normalization and the recursive least squares approach to deliver a more stable and efficient adaptive filtering process. FxNRLS may minimize cumulative error through recursive updates while incorporating normalization techniques to more effectively manage variations in signal amplitude. This dual approach may enable FxNRLS to achieve rapid convergence with lower sensitivity to noise fluctuations, making it suitable for real-time applications where both speed and stability are crucial, such as active noise control in high-performance audio systems or adaptive communication networks.

For example, the controller 330 may use the adaptive filter 332, the secondary path model 334, and the adaptive filter controller 336 to generate the noise control signal y(n). For example, the adaptive filter 332 may receive the reference signal x(n) and generate the noise control signal y(n) for removing the noise signal d(n). A transfer function of the adaptive filter 332 may be expressed as W(z), and the transfer function W(z) of the adaptive filter 332 may represent at least one filter coefficient. The noise control signal y(n) may be derived by convolution computation between the reference signal x(n) and the transfer function W(z) of the adaptive filter 332.

The noise control signal y(n) may be output through the speaker and may be transformed as noise control signal y(n) passes through the secondary path 320. For example, if the position of the ear of the occupant is treated as the same as the position of the microphone, the secondary path 320 may be a path between the speaker and the microphone. For example, the noise control signal y(n) may become the transformed noise control signal y′(n) at the position of the physical microphone. The transformed noise control signal y′(n) and the noise signal d(n) may cancel each other out at the position of the physical microphone. Even if the noise control signal y(n) at the position of the speaker is generated to be the same as the noise signal d(n), the noise control signal y′(n) transformed through the secondary path 320 may be different from d(n), and residual noise may be generated at the position of the physical microphone.

The residual noise at the physical microphone position may be measured as the error signal e(n) by the physical microphone. For example, the error signal e(n) may represent residual noise remaining after the noise signal d(n) is canceled out by the noise control signal y(n) at a noise control point such as the physical microphone position.

To remove the error signal e(n), the controller 330 may update filter coefficients of the adaptive filter 332 based on the reference signal x(n) and the error signal e(n). For example, the adaptive filter controller 336 implemented on the controller 330 may update the filter coefficients by considering that the noise control signal y(n) is transformed by the secondary path 320 after the noise control signal y(n) is output from the speaker.

The error signal e(n) may represent the residual noise measured at the position of the physical microphone and is therefore different from the residual noise at positions of an ear of the occupant. Even though the microphone for measuring the error signal e(n) is disposed close to the position of the ear of the occupant, the residual noise at the position of the ear of the occupant may be a virtual error signal e′(n) rather than the error signal e(n) due to a difference in distance between the position of the microphone and the position of the ear of the occupant.

For example, it may be necessary to estimate the virtual error signal e′(n) at the position of the ear of the occupant and remove the virtual error signal e′(n).

For example, a transfer function S′(z) of the secondary path model 334, which may represent the acoustic transfer characteristic for the secondary path 320, may be estimated in advance. For example, if there is no noise in the vehicle, the secondary path model 334 may be estimated from the output of the speaker and the input of the microphone. Additionally or alternatively, the secondary path 320 may be modeled by an engineer in the noise control field using an appropriate method among modeling methods to best explain a physical phenomenon of an actual audio system.

The controller 330 may apply the secondary path model 334 to the reference signal x(n), so that the reference signal x(n) may become the filtered reference signal x′(n). The filtered reference signal x′(n) may be input to the adaptive filter controller 336.

The virtual error signal estimator 338 may estimate the virtual error signal e′(n) at the position of the ear of the occupant based on the noise control signal y(n) and the error signal e(n). The virtual error signal estimator 338 may generate a virtual microphone at the position of the ear of the occupant based on the noise control signal y(n) and the error signal e(n). Unlike a physical microphone, the virtual microphone may have a concept for estimating acoustic signals from the position of the ear of the occupant. The virtual error signal estimator 338 may measure the virtual error signal e′(n) at the position of the ear of the occupant using the virtual microphone.

For example, the virtual error signal estimator 338 may store a first acoustic transfer characteristic from the speaker to the physical microphone, a second acoustic transfer characteristic from the position of the physical microphone to the expected position of the ear of the occupant, and/or a third acoustic transfer characteristic from the speaker to the expected position of the ear of the occupant in advance. For example, the virtual error signal estimator 338 may apply the first acoustic transfer characteristic to the noise control signal y(n) to estimate the transformed noise control signal y′(n) at the position of the physical microphone. The virtual error signal estimator 338 may estimate the noise signal d(n) at the position of the physical microphone by subtracting the transformed noise control signal y′(n) from the error signal e(n). For example, the virtual error signal estimator 338 may estimate the virtual noise signal d′(n) at the expected position of the ear of the occupant by applying the second acoustic transfer characteristic to the noise signal d(n). For example, the virtual error signal estimator 338 may estimate a virtual noise control signal y″(n) at the expected position of the ear of the occupant by applying the third acoustic transfer characteristic to the noise control signal y(n). The virtual noise control signal y″(n) may be a signal estimated to have the same magnitude as and an antiphase with respect to the virtual noise signal d′(n) at the expected position of the ear of the occupant. The virtual noise signal d′(n) may not be the same as the virtual noise control signal y″(n) due to various factors. Accordingly, the virtual error signal estimator 338 may add the virtual noise signal d′(n) to the virtual noise control signal y″(n) to acquire a virtual error signal e′(n) representing virtual residual noise remaining after the virtual noise signal d′(n) being removed by the virtual noise control signal y″(n).

For example, the adaptive filter controller 336 may apply a least mean square (LMS) algorithm to the filtered reference signal x′(n) and the virtual error signal e′(n) to update the filter coefficients of the adaptive filter 332. For example, an LMS algorithm may comprise an adaptive filtering technique that may be used in signal processing to minimize the error between a desired signal and an estimated signal. The LMS algorithm may adjust the filter's coefficients iteratively to reduce the mean square error, using a gradient descent approach. The LMS algorithm may continuously update the filter parameters based on changes in the input signal, allowing it to adapt in real-time to varying conditions.

The filter coefficients may be updated so that the virtual error signal e′(n) becomes zero. The filter coefficient W(z) may be updated by gradient descent.

The updated adaptive filter 332 may generate the noise control signal y(n) from the reference signal x(n). If the noise control signal y(n) is output from the speaker, the virtual error signal e′(n) measured at the virtual microphone position is minimized. For example, noise according to the reference signal x(n) may be removed as much as possible at the expected position of the ear of the occupant.

Through the above-described process, the controller 330 may adaptively generate the noise control signal y(n).

Additionally or alternatively the virtual error signal estimator 338 may be omitted. For example, the adaptive filter controller 336 may update the filter coefficients of the adaptive filter 332 so that the error signal e(n) becomes zero based on the filtered reference signal x′(n) and the error signal e(n).

Unless the controller 330 included in the vehicle is an expensive digital signal processor, it may be difficult for the controller 330 to perform all of the above-described signal processing due to performance limitations. For example, in the noise control algorithm, the update of the filter coefficients of the adaptive filter 332 may require a largest amount of computation, and convolution computation between the adaptive filter 332 and the reference signal x(n) for generating the noise control signal y(n), and virtual microphone processing computation of the virtual error signal estimator 338 occupy a second high proportion. For example, filter coefficient update may require a much larger amount of computation than other computations. For example, the filter coefficient update may account for 85 percent of a total amount of computation of the noise control algorithm. There may be a limit for the controller 330 to process all of these computations.

For example, according to one example of the present disclosure, the noise control algorithm may be distributedly processed.

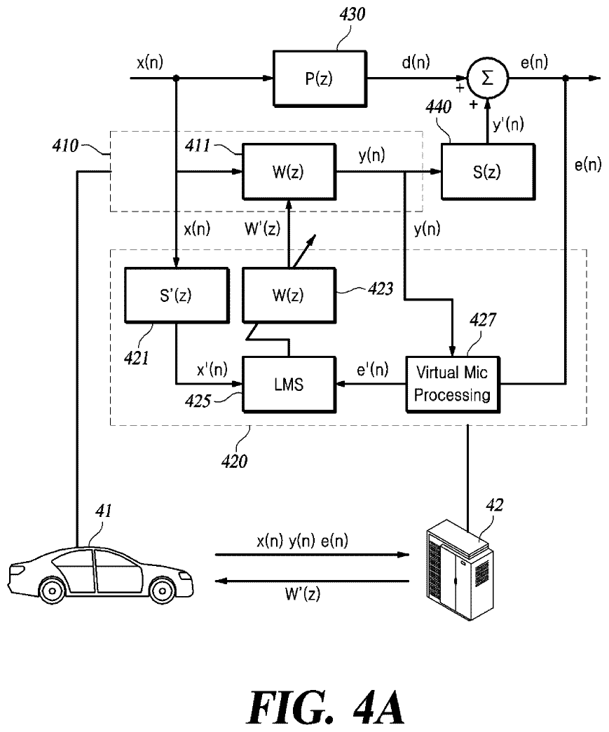

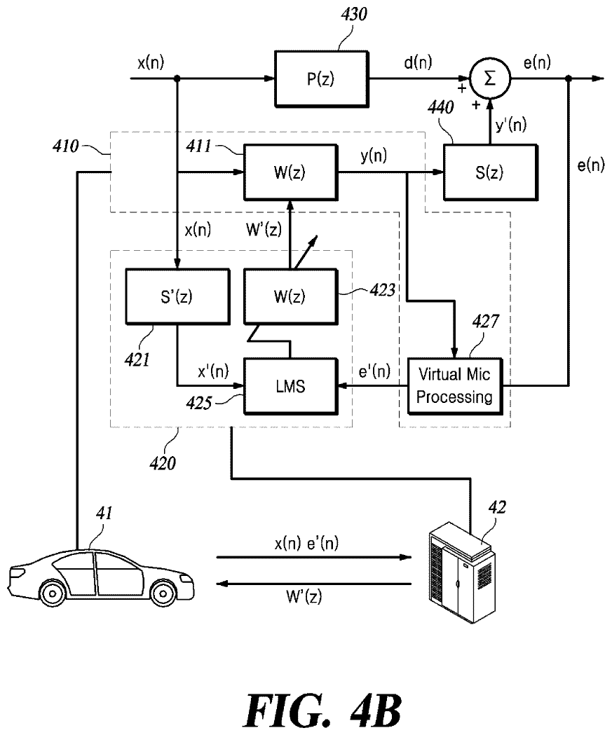

FIG. 4A and FIG. 4B show examples of diagrams showing the remote ANC system according to various examples of the present disclosure.

Referring to FIG. 4A and FIG. 4B, the remote anti-noise cancelling (ANC) system may include a vehicle 41 and a server 42. The remote ANC system may be a system for performing processing with the noise control algorithm distributed to the vehicle 41 and the server 42.

The noise control algorithm shown in FIG. 4A and FIG. 4B may be the same or similar to the noise control algorithm shown in FIG. 3. An adaptive filter controller 425 may perform an operation of the adaptive filter controller 336, and the secondary path model 421 may be the same as the secondary path model 334. For example, the virtual error signal estimator 427 may perform a function of the virtual error signal estimator 338. The noise control algorithm of FIG. 4 may be partially performed not only in the vehicle 41 but also in the server 42.

The vehicle 41 may include a controller 410 with relatively limited performance, and the server 42 may include a computation device 420 with relatively higher performance. For example, the vehicle 41 and the server 42 each may include communication devices for wireless communication with each other. The communication devices may perform a variety of communications, including several generations of mobile communication technologies, local area network (LAN) communications, and vehicle-to-everything (V2X) communications. Further, the server 42 may be a cloud computation device, and server 42 may provide a filter coefficient update operation to be described below to numerous vehicles.

For example, the reference signal x(n) may be collected from the reference sensor of the vehicle 41. The controller 410 in the vehicle 41 may generate the noise control signal y(n) by applying a local adaptive filter 411 to the reference signal x(n). At the same time, the error signal e(n) may be measured at the microphone in the vehicle 41.

The vehicle 41 may transmit the reference signal x(n), the noise control signal y(n), and the error signal e(n) to the server 42.

The computation device 420 in the server 42 may update the filter coefficients of the remote adaptive filter 423 using the reference signal x(n), the noise control signal y(n), and the error signal e(n). The computation device 420 may accelerate processing of the noise control algorithm by performing a filter coefficient update, which takes up the largest amount of computation in the noise control algorithm. For example, since an update process of the remote adaptive filter 423 is the same as a filter coefficient update process of the adaptive filter 332 described in FIG. 3, detailed description thereof may be omitted.

The computation device 420 may acquire an updated filter coefficient W′(z) as a result of updating the remote adaptive filter 423, and transmit the updated filter coefficient W′(z) to the controller 410 of the vehicle 41 through wireless communication.

The controller 410 may receive the updated filter coefficient W′(z) and replace the filter coefficient W(z) of the local adaptive filter 411 with the updated filter coefficient W′(z). For example, the reference signal x(n) may become the noise control signal y(n) through computation with the updated filter coefficient W′(z).

Through repetition of the above-described processes, the vehicle 41 and the server 42 in the remote ANC system may implement the noise control algorithm.

For example, the low-performance controller 410 may perform replacement and application of the local adaptive filter 411 which may require a small amount of computation, and the high-performance computation device 420 may perform a filter coefficient update operation of the adaptive filter controller 425 which may require a large amount of computation. For example, since the noise control algorithm is distributedly processed, the update of the filter coefficient for the local adaptive filter 411 may be performed quickly without delay.

For example, it may be possible to change adaptive control algorithms of all vehicles connected to the server 42 by changing only an adaptive control algorithm of the adaptive filter controller 425 of the server 42 without changing software of controllers included in all vehicles. A user (for example, a developer, tester, or occupant) may access the server 42 through a separate terminal, and change the adaptive control algorithm to be applied to noise control of the vehicle 41. For example, the user may access the server 42 and tune parameters of various functions (e.g., a sampling rate of the reference sensor or a filter update cycle) that may be performed in the vehicle 41 or the server 42. If a parameter related to the vehicle 41 is changed, the server 42 may transmit a command to instruct to change the parameter to the vehicle 41.

Additionally or alternatively, a function of the virtual error signal estimator 427 may be performed by the vehicle 41, as shown in FIG. 4B. For example, the vehicle 41 may transmit the reference signal x(n) and the virtual error signal e′(n) to the server 42, and the server 42 may generate and return the updated filter coefficient W′(z). Additionally or alternatively, the vehicle 41 may further transmit a noise control signal y(n) and/or an error signal e(n). The server 42 may monitor a result of performing noise control on the basis of the received noise control signal y(n) and/or error signal e(n).

Additionally or alternatively, the vehicle 41 may transmit the reference signal x(n) and the error signal e(n) to the server 42, and the server 42 may generate and return the noise control signal y(n). A problem such as low noise control performance due to increased latency and increased latency may occur as compared to a scheme in which the server 42 transmits the updated filter coefficient W′(n).

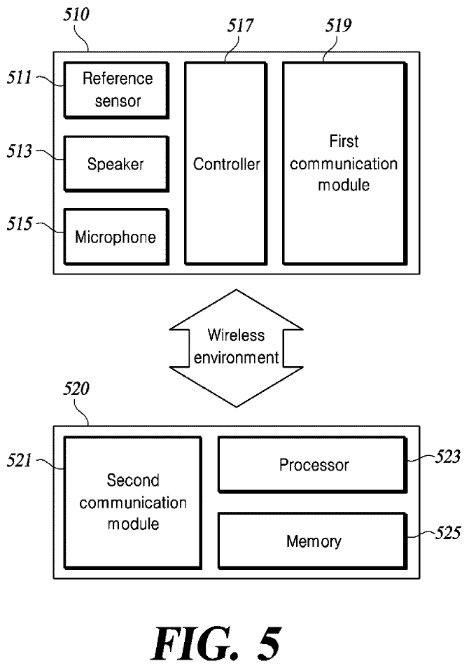

FIG. 5 shows an example configuration diagram of the remote ANC system according to the example of the present disclosure.

Referring to FIG. 5, the remote ANC system may include a vehicle 510 and a server 520.

The vehicle 510 may include reference sensors 511, speakers 513, microphones 515, a controller 517 (e.g., an ANC controller), and a first communication module 519. Each of the reference sensors 511 may be an accelerometer, and measures an acceleration signal as a reference signal while the vehicle 510 is traveling. Each of the speakers 513 may output the noise control signal. Each of the microphones 515 may receive the error signal. The controller 517 (e.g., the ANC controller) may apply the updated filter coefficient received from the server 520 to the reference signal to generate the noise control signal. The first communication module 519 may support connection for wireless communication with the server 520 and exchanges signals and filter coefficients with the second communication module 521 of the server 520. For example, the first communication module 519 may include a signal buffer for synchronization.

The server 520 may include a second communication module 521, a processor 523, and a memory 525. The second communication module 521 may support wireless communication with the first communication module 519. For example, the second communication module 521 may include a signal buffer for synchronization. The processor 523 may update the remote adaptive filter using the reference signal, the noise control signal, and the error signal received from the vehicle 510. For example, the processor 523 may execute functions of the computation device 420. The memory 525 may store instructions for enabling the processor 523 to perform filter coefficient update.

The server 520 may update the filter coefficient at regular time intervals and periodically. For example, an update period of the filter coefficient may be set to 64 ms. The server 520 may update the filter coefficient every 64 ms based on a signal received from the vehicle 510. If the update period of the filter coefficient in the server 520 is shorter, noise control performance in the vehicle 510 may be further improved.

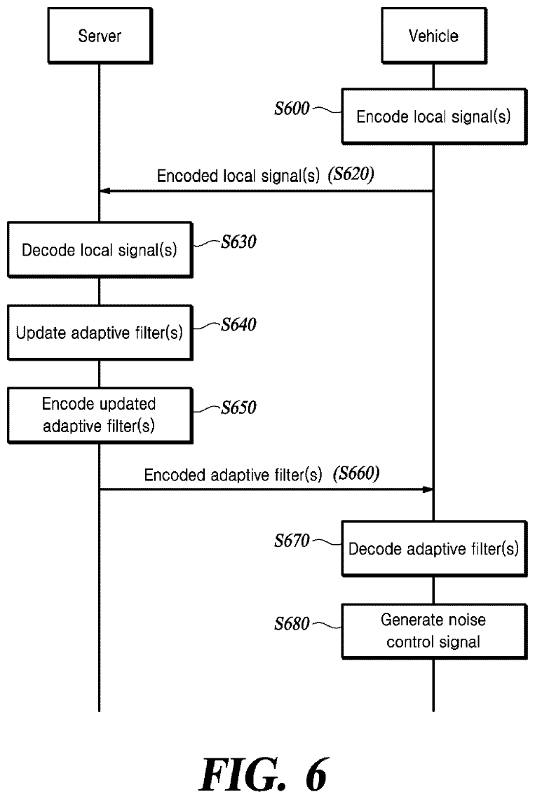

FIG. 6 shows an example flowchart showing a remote ANC method according to an example of the present disclosure.

Continuous exchange of various local signals and updated filter coefficients between the vehicle and the server may be required in order to perform distributed processing on the noise control algorithm in the remote ANC system. An amount of data exchanged between the vehicle and the server may be very large. If a large amount of data is transmitted as is, the overall performance of the remote ANC system may be degraded due to a transmission delay, error, or the like. It may be necessary to reduce an amount of data transmission.

The vehicle may encode (or compress) one or more local signals (S600) and transmit the encoded local signals to the server (S610). Each local signal may be a multi-channel signal having a plurality of channels. For example, the reference signal may have as many channels as the number of reference sensors disposed in the vehicle. The noise control signal may have as many channels as the number of speakers disposed in the vehicle. The error signal may have as many channels as the number of microphones disposed in the vehicle. The virtual error signal may have as many channels as the number of virtual microphones.

The server may decode (or decompress) the encoded local signals to the original local signals (S630) and update adaptive filters based on them (S640). The number of adaptive filters may be determined by the number of channels of the reference signal (e.g., the number of reference sensors) and the number of channels of the noise control signal (e.g., the number of speakers). For example, if the numbers of reference sensors and speakers disposed in the vehicle are R and K, respectively, R×K adaptive filters may be used for noise control.

The server may encode (or compress) the updated adaptive filters (S650) and/or transmit the encoded adaptive filters to the vehicle (S660). The vehicle may decode (or decompress) the encoded adaptive filters to the adaptive filters updated by the server (S670) and generate the noise control signal by using the adaptive filters (S680).

In steps S600 and S630, the vehicle and the server may encode and/or decode local signals using an Adaptive Differential Pulse Code Modulation (ADPCM) algorithm. For example, an Adaptive Differential Pulse Code Modulation (ADPCM) algorithm may comprise an audio compression algorithm that may reduce the amount of data required to represent sound by encoding the difference between consecutive audio samples, rather than the actual samples.

In steps S650 and S670, the vehicle and the server may encode and/or decode the adaptive filters using an ADPCM algorithm. For example, the ADPCM algorithm may comprise a technology for efficiently compressing Pulse Code Modulation (PCM) signals using adaptive quantization and/or differential predictive coding.

In steps S620 and S660, the local signals and the adaptive filters may be split into a plurality of packets and transmitted. The vehicle and the server may use User Datagram Protocol (UDP) to transmit and receive data. For example, User Datagram Protocol (UDP) may comprise a communication protocol that may be used in networking for transmitting data over the Internet. For example, UDP may be connectionless and may not require a dedicated connection between a sender and a receiver. UDP may send data in small packets called datagrams without checking for errors or ensuring delivery order. UDP may be useful in applications where speed may be important and occasional data loss may be acceptable.

A remote ANC system may require high transmission speed of large data rather than transmission reliability. For example, the vehicle and the server may dispose an important information element in a front part of the packet in preparation for a case where some packet loss may occur. The important information element may include an information element for identifying whether a packet (or specific data within the packet) is lost. For example, the vehicle and the server may identify which packet (or data) has been lost, and partially utilize a non-lossy part.

Tables 1 and 2 show data included in a payload of a UDP packet transmitted from the vehicle to the server, and data included in a payload of a UDP packet transmitted from the server to the vehicle, respectively.

TABLE 1
Example of data structure transmitted from vehicle to server

Time Index,
Control Status,
Signal Data Dimension, Signal Data,
ETC

TABLE 2
Example of data structure transmitted from server to vehicle

Time Index,
Control Status,
Filter Data Dimension, Filter Data,
ETC

The packet transmitted from the vehicle to the server may include a time index field, a control status field, a signal data dimension field, a signal data field, and/or other fields.

The packet transmitted from the server to the vehicle may include a time index field, a control status field, a filter data dimension field, a filter data field, and/or other fields.

The time index field may contain information necessary for confirmation of a packet loss, packet shuffling, and a delay time at the time of transmission and reception of data.

The control status field may contain information indicating an ANC control status. The ANC control status may be an idle status in which ANC control may be disabled, a modeling status in which noise characteristics of a surrounding environment are analyzed and modeled, and/or a control status if control of noise removal is performed on the basis of the modeled information, but is not limited to.

The signal data field may contain samples of time series data such as the reference signal, the noise control signal, the error signal, and/or the virtual error signal, and the signal data dimension field may contain information indicating the number of dimensions of the data contained in the signal data field.

The filter data field may contain filter coefficients of the adaptive filter and/or secondary path filter coefficients, and the filter data dimension field may contain information indicating the number of dimensions of data contained in the filter data field.

The other fields may contain, for example, checksum data for packet error checking.

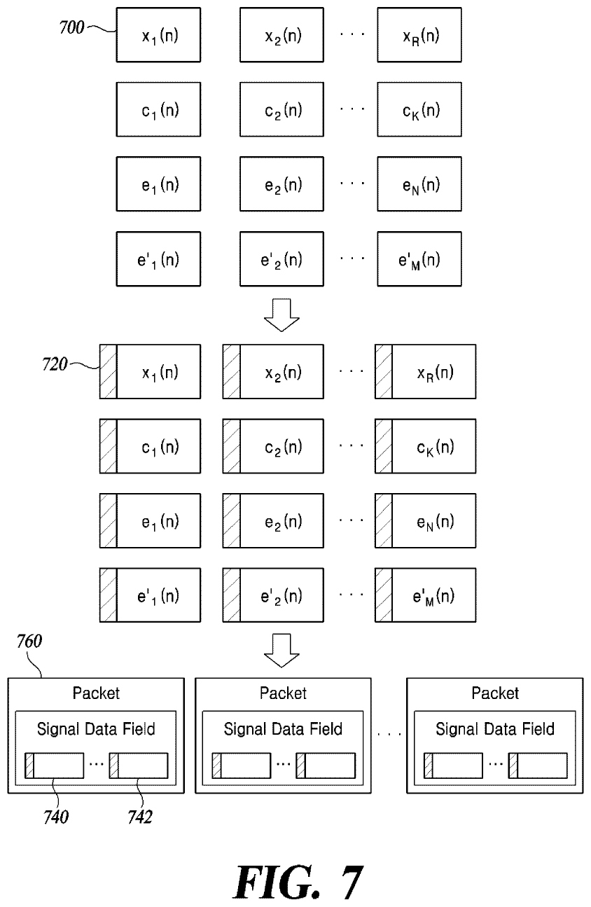

FIG. 7 shows an example diagram showing a data structure for transmitting and receiving a local signal according to an example of the present disclosure.

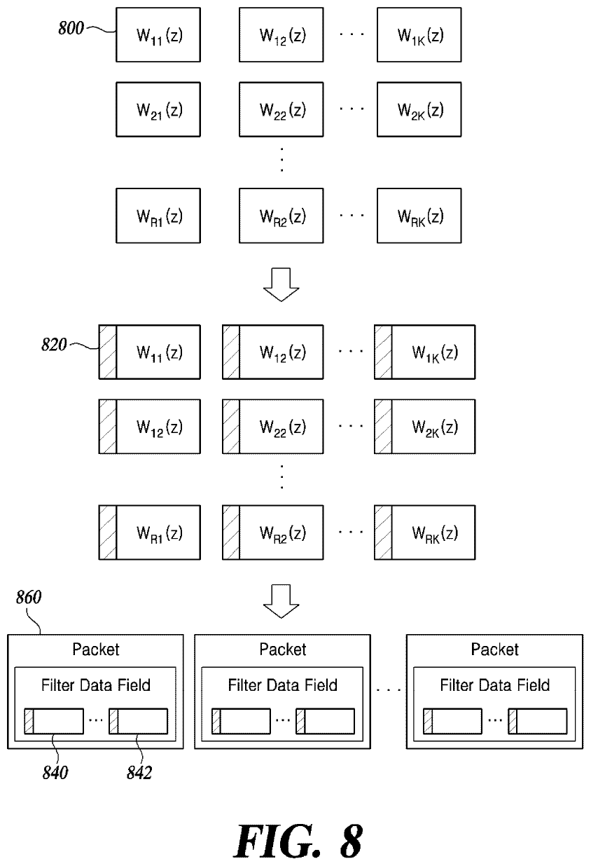

FIG. 8 shows an example diagram showing a data structure for transmitting and receiving an adaptive filter according to an example of the present disclosure.

If all calculations for noise control are performed only within the vehicle, local signals and/or adaptive filters may be exchanged between in-vehicle modules responsible for respective functions according to pre-arranged timing and order. Accordingly, each module may identify a channel to which a currently received data corresponds, for example, on the basis of a data reception time point and a receiving order.

In a remote ANC system, packet loss, packet shuffling, and/or packet delay may occur in a process of exchanging local signals and/or adaptive filters through wireless communication. This may make it difficult for the server and/or the vehicle to exchange data according to a predefined timing and order. For example, the server may not identify which channel of a certain local signal pieces of data in a currently received packet is for, and the vehicle may not identify the adaptive filter of a certain channel the pieces of data in the currently received packet is for. The vehicle and/or the server may insert an identifier for distinguishing between the channels of the respective pieces of data into a front end of the data for each channel.

For example, referring to FIG. 7, the vehicle may insert channel information 720 into a front part of signal data 700 for each channel to construct a chunk, and transmit one or more chunks 740 to 742 to the server, with the chunks 740 to 742 put in a signal data field a packet 760. In FIG. 7, x_{R}, c_{K}, e_{N}, and e′_{M} may indicate samples of a reference signal measured by an R^{th} reference sensor, samples of the noise control signal output to a K^{th} speaker, samples of the error signal measured by an N^{th} microphone, and samples of a virtual error signal estimated by the M^{th} virtual microphone, respectively. The channel information 720 may be an identifier indicating whether subsequent pieces of data may be samples of a certain channel of a certain local signal. The server may use the channel information to identify samples of which local signal and which channel the data subsequent to the channel information are. If some packets are lost in a process of transmitting the local signals, the server may partially utilize samples of a specific local signal and/or a specific channel that have not been lost, for example, on the basis of an identification result.

Within one control cycle, a total number of chunks that the vehicle may transmit to the server may be determined, for example, on the basis of the channel numbers of each local signal. For example, if the number of channels of the reference signal, the noise control signal, the error channel signal, and the virtual error signal are R, K, N, and M, respectively, (R+K+N+M) chunks may be transmitted to the server. Within one control cycle, the total number of packets that the vehicle transmits to the server may vary depending on a total number of chunks, a length of each chunk (that is, a sum of a length of the channel information and the number of samples of one channel of the local signal), and/or a length of the signal data field.

Additionally or alternatively, referring to FIG. 8, the server may insert channel information 820 into a front part of filter data 800 for each channel to construct a chunk, and transmit one or more chunks 840 to 842 to the server, with the chunks 840 to 842 put in the filter data field a packet 860. In FIG. 8, W_{RK} may represent coefficients of an adaptive filter corresponding to the R^{th} reference sensor and the K^{th} speaker. The channel information 820 may be an identifier indicating filter coefficients of which channel the subsequent data are. The vehicle may use the channel information to identify the filter coefficients of which channel of the adaptive filter the pieces of data subsequent to the channel information are. If some packets are lost in a process of transmitting the adaptive filters, the server may partially utilize filter coefficients of a specific channel that have not been lost on the basis of an identification result.

Within one control cycle, the total number of chunks that the server transmits to the vehicle may be determined, for example, on the basis of the number of channels of the adaptive filter (e.g., a product of the number of channels of the reference signal and the number of channels of the noise control signal). For example, if the numbers of channels of the reference signal and the noise control signal are R and K, respectively, (R×K) chunks may be transmitted to the vehicle. Within one control cycle, the total number of packets that the server transmits to the vehicle may vary depending on the total number of chunks, the length of each chunk (that is, a sum of the length of the channel information and the number of filter coefficients in one channel), and/or a length of the filter data field.

FIGS. 7 and 8 show examples in which samples of one channel of a local signal (or coefficients of one channel of an adaptive filter) are grouped into one chunk and transmitted through one packet, but the present disclosure is not limited thereto. For example, the samples (or coefficients) of single channel may be split into multiple packets and transmitted. For example, each packet may also contain an information element indicating that the local signal (or adaptive filter) of a specific channel has been split and transmitted, and/or an information element indicating which part of the entire samples (or coefficients) pieces of data in a current packet corresponds to.

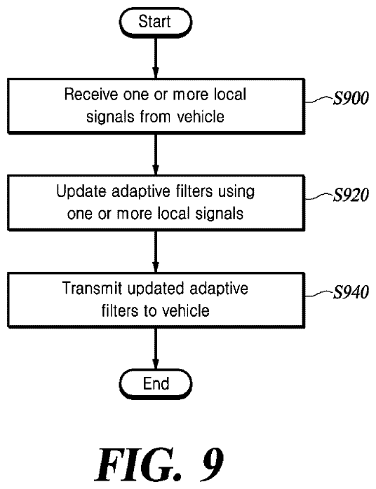

FIG. 9 shows an example flowchart showing an adaptive filter update method according to an example of the present disclosure.

The server may receive one or more local signals from the vehicle (S900). The one or more local signals may be associated with noise control by an ANC controller of the vehicle. Each local signal, of the one or more local signals, may be the reference signal, the noise control signal, the error signal, or the virtual error signal. For example, the server may receive the reference signal, the noise control signal, and/or the error signal from the vehicle. Additionally or alternatively, the server may receive the reference signal and/or the virtual error signal from the vehicle. Additionally or alternatively, the server may receive all of the reference signal, the noise control signal, the error signal, and/or the virtual error signal from the vehicle.

Each local signal, of the received one or more local signals, may be a multi-channel signal associated with a plurality of channels. For example, each local signal may have a plurality of channels. The server may parse one or more packets received from the vehicle and extract samples for each channel of each local signal. The server may extract samples for each channel of each local signal of the received one or more local signals, based on the parsed one or more packets. Each of one or more packets may contain one or more chunks. Each of the one or more chunks may contain a group of samples corresponding to a combination of certain local signal and certain channel, and/or channel information of the combination of the certain local signal and the certain channel. The group of samples may include at least some of samples corresponding to certain channel of the certain local signal. For example, each of the one or more chunks may include at least one of samples corresponding to a combination of a certain local signal of the received one or more local signals and a certain channel of the plurality of channels associated with the certain local signal. The channel information may include an identifier assigned to distinguish the certain local signal from other local signals of the received one or more local signals and distinguish the certain channel from other channels of the plurality of channels of the certain local signal. The channel information may be inserted before the samples for each corresponding combination within each chunk. For example, in each of the one or more chunks, the channel information may precede the group of samples. For example, the channel information may precede the at least one of samples in each respective chunk of the one or more chunks.

The server may update the adaptive filters using one or more local signals (S920). For example, the server may update the adaptive filters of the remote ANC system. The adaptive filters may be provided for each of the plurality of channels corresponding to combinations of the reference signal and the noise control signal. The updated adaptive filters may be associated with the plurality of channels. Each of the plurality of channels may correspond to a combination of the reference signal of a respective channel of the plurality of channels and the noise control signal of a respective channel of the plurality of channels. For example, if the reference signal has R channels and the noise control signal has K channels, R x K adaptive filters may be used. The server may use the one or more local signals to update all or some of a plurality of adaptive filters. Updating the adaptive filter may include updating coefficients of the adaptive filter.

The server may transmit the updated adaptive filter to the vehicle (S940).

The server may transmit an adaptive filter for each channel using one or more packets each containing one or more chunks. The server may transmit each of the updated adaptive filters via one or more packets. The server may put the adaptive filters corresponding to the different channels in different chunks contained in a single packet or different multiple packets and transmit the using one or more packets. For example, some adaptive filters, of the updated adaptive filters, corresponding to different channels may be put in different chunks of a single packet. Additionally or alternatively, some adaptive filters, of the updated adaptive filters, corresponding to different channels may be put in different packets of the one or more packets. Each of the one or more chunks may contain a group of coefficients of an adaptive filter corresponding to a certain channel, and/or channel information of the certain channel. The group of coefficients may include at least some of filter coefficients corresponding to the certain channel. For example, each of the one or more chunks includes at least one of coefficients of a respective adaptive filter, of the updated adaptive filters, corresponding to a certain channel of the plurality of channels. The channel information may include an identifier assigned to distinguish the certain channel from other channels of the plurality of channels (e.g., R×K channels). The channel information may be inserted before the adaptive filter within each chunk. For example, in each of the one or more chunks, the channel information may precede the group of coefficients. For example, the channel information may precede at least one of coefficients of the respective adaptive filter in each respective chunk of the one or more chunks.

In step S900 and/or step S940, each of the one or more packets may further contain a data dimension of one or more chunks. For example, each of the one or more packets may further include an indication of the data dimension of the one or more chunks. The data dimension may be inserted before the one or more chunks. For example, the indication of the data dimension may precede the one or more chunks in each respective packet of the one or more packets. Additionally or alternatively, each of the one or more packets may further contain a time index, ANC control status information, or a combination thereof. The time index and/or the control status information may be inserted before the data dimension. For example, the at least one of the time index or the ANC control status information may precede the indication of the data dimension in each respective packet of the one or more packets.

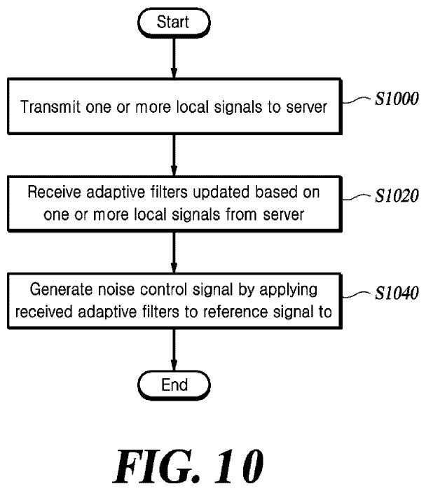

FIG. 10 shows an example flowchart showing a method of generating the noise control signal according to an example of the present disclosure.

The vehicle may transmit one or more local signals to the server (S1000). The vehicle associated with a remote ANC system may transmit the one or more local signals to the server to associated with a remote ANC system. The one or more local signals may be associated with noise control by an ANC controller of the vehicle. Each local signal, of the transmitted one or more local signals, may be a reference signal, a noise control signal, an error signal, or a virtual error signal. For example, the vehicle may transmit the reference signal, the noise control signal, and/or the error signal to the server. Additionally or alternatively, the vehicle may transmit the reference signal and/or the virtual error signal to the server. Additionally or alternatively, the vehicle may transmit all of the reference signal, the noise control signal, the error signal, and/or the virtual error signal to the server.

Each local signal, of the received one or more local signals, may be a multi-channel signal associated with a plurality of channels. For example, each local signal may have a plurality of channels. The vehicle may transmit samples for each channel of each local signal of the one or more local signals to the server via one or more packets. The vehicle may transmit samples for each channel of each local signal using one or more packets each containing one or more chunks. The vehicle may put the samples corresponding to the different channels in different chunks contained in a single packet or different multiple packets and transmit the one or more packets. For example, some samples, of samples of a certain local signal, corresponding to different channels may be put in different chunks of a single packet. Additionally or alternatively, some samples, of samples of a certain local signal, corresponding to different channels may be put in different packets of the one or more packets. Each of the one or more chunks may contain a group of samples corresponding to a combination of certain local signal and certain channel of the local signal, and/or channel information of the combination of the certain local signal and channel. The group of samples may include at least some of samples corresponding to certain channel of the certain local signal. For example, each of the one or more chunks includes at least one of samples corresponds to the combination of a certain local signal of the one or more local signals and a certain channel of the plurality of channels of the certain local signal. The channel information may include an identifier assigned to distinguish the certain local signal from other local signals of the one or more local signals and distinguish the certain channel from other channels of the plurality of channels of the certain local signal. The channel information may be inserted before the samples for each corresponding combination within each chunk. For example, in each of the one or more chunks, the channel information may precede the group of samples. The channel information may precede the at least one of samples in each respective chunk of the one or more chunk.

The vehicle may receive the adaptive filters updated based on the one or more local signals from the server (S1020). For example, the vehicle may receive the adaptive filters of the remote ANC system.

The adaptive filters may be provided for each of the plurality of channels corresponding to combinations of the reference signal and the noise control signal. The received adaptive filters may be associated with the plurality of channels. Each of the plurality of channels may correspond to a combination of the reference signal of a respective channel of the plurality of channels and the noise control signal of a respective channel of the plurality of channels. The vehicle may parse one or more packets received from the server and extract an adaptive filter corresponding to each of the plurality of channels. The vehicle may extract, based on the parsed one or more packets, each of the received adaptive filters corresponding to a respective channel of the plurality of channels. Each of the one or more packets may contain one or more chunks. Each of the one or more chunks may contain a group of coefficients of an adaptive filter corresponding to a certain channel, and/or channel information of the certain channel. The group of coefficients may include at least some of filter coefficients corresponding to the certain channel. For example, each of the one or more chunks includes at least one of coefficients of a respective adaptive filter, of the received adaptive filters, corresponding to a certain channel of the plurality of channels. The channel information may include an identifier assigned to distinguish the certain channel from other channels of the plurality of channels (e.g., R×K channels). The channel information may be inserted before the adaptive filter within each chunk. For example, in each of the one or more chunks, the channel information may precede the group of coefficients. For example, the channel information may precede the at least one of coefficients of the respective adaptive filter in each respective chunk of the one or more chunks.

The vehicle may generate the noise control signal by applying the updated adaptive filter to the reference signal (S1040). For example, the ANC controller of the vehicle may generate the noise control signal by applying the updated adaptive filter to the reference signal.

In step S1000 and/or step S1020, each of the one or more packets may further contain a data dimension of one or more chunks. For example, each of the one or more packets may further include an indication of the data dimension of the one or more chunks. The data dimension may be inserted before the one or more chunks. For example, the indication of the data dimension may precede the one or more chunks in each respective packet of the one or more packets. Additionally or alternatively, each of the one or more packets may further contain a time index, ANC control status information, or a combination thereof. The time index and/or the control status information may be inserted before the data dimension. For example, the at least one of the time index or the ANC control status information may precede the indication of the data dimension in each respective packet of the one or more packets

According to at least one example, the present disclosure provides a computer-implemented method of updating adaptive filters in a remote ANC system. The computer-implemented method includes receiving one or more local signals from a vehicle, wherein each local signal includes a reference signal, a noise control signal, an error signal, or a virtual error signal, updating the adaptive filters using the one or more local signals, and transmitting the updated adaptive filter to the vehicle.

According to another example, the present disclosure provides a method performed in a vehicle of a remote ANC system. The method includes transmitting one or more local signals to a server, wherein each local signal includes a reference signal, a noise control signal, an error signal, or a virtual error signal, receiving, from the server, adaptive filters updated based on the one or more local signals from the server, and generating a noise control signal by applying the received adaptive filters to the reference signal.

According to yet another example, the present disclosure provides a device for updating an adaptive filter in a ANC system. The device includes a memory configured to store instructions, and at least one processor. The at least one processor executes the instructions to receive one or more local signals from a vehicle, each local signal including a reference signal, a noise control signal, an error signal, or a virtual error signal, update the adaptive filter using the one or more local signals, and transmit the updated adaptive filter to the vehicle.

According to yet another example, the present disclosure provides a device included in a vehicle in a remote ANC system. The device includes a memory configured to store instructions, and at least one processor. The at least one processor executes the instructions to transmit one or more local signals to a server, wherein each local signal includes a reference signal, a noise control signal, an error signal, or a virtual error signal, receive, from the server, adaptive filters updated based on the one or more local signals from the server, and generate a noise control signal by applying the received adaptive filters to the reference signal.

Each component of the apparatus or method according to the present disclosure may be implemented as hardware or software, or a combination of hardware and software. Furthermore, the function of each component may be implemented as software and a microprocessor may be implemented to execute the function of software corresponding to each component.

Various implementations of systems and techniques described herein may be realized as digital electronic circuits, integrated circuits, field programmable gate arrays (FPGAs), application-specific integrated circuits (ASICs), computer hardware, firmware, software, and/or combinations thereof. These various implementations may include one or more computer programs executable on a programmable system. The programmable system includes at least one programmable processor (which may be a special-purpose processor or a general-purpose processor) coupled to receive and transmit data and instructions from and to a storage system, at least one input device, and at least one output device. The computer programs (also known as programs, software, software applications, or codes) contain commands for a programmable processor and are stored in a “computer-readable recording medium”.

The computer-readable recording medium includes all types of recording devices in which data readable by a computer system is stored. Such a computer-readable recording medium may be a non-volatile or non-transitory medium, such as a read-only memory (ROM), compact disk ROM (CD-ROM), magnetic tape, floppy disk, memory card, hard disk, magneto-optical disk, or storage device, and may further include a transitory medium such as a data transmission medium. In addition, the computer-readable recording medium may be distributed in a computer system connected via a network, so that computer-readable codes may be stored and executed in a distributed manner.

The flowchart/timing diagram of the present specification describes that processes are sequentially executed, but this is merely illustrative of the technical idea of an example of the present disclosure. In other words, since it is apparent to those having ordinary skill in the art that an order described in the flowchart/timing diagram may be changed or one or more processes may be executed in parallel without departing from the essential characteristics of an example of the present disclosure, the flowchart/timing diagram is not limited to a time-series order.

Although exemplary examples of the present disclosure have been described for illustrative purposes, those having ordinary skill in the art should appreciate that various modifications, additions, and substitutions are possible, without departing from the idea and scope of the claimed disclosure. Therefore, exemplary examples of the present disclosure have been described for the sake of brevity and clarity. The scope of the technical idea of the present examples is not limited by the illustrations. Accordingly, one of ordinary skill in the art would understand that the scope of the claimed disclosure is not to be limited by the above explicitly described examples but by the claims and equivalents thereof.

What is claimed is:

1. A computer-implemented method of updating adaptive filters in a remote active noise control (ANC) system, the computer-implemented method comprising:
receiving one or more local signals from a vehicle, wherein the one or more local signals are associated with noise control by an ANC controller of the vehicle, and wherein each local signal, of the one or more local signals, comprises a reference signal, a noise control signal, an error signal, or a virtual error signal;
updating, using the one or more local signals, the adaptive filters of the remote ANC system; and
transmitting, to the vehicle, the updated adaptive filter to adjust the ANC controller of the vehicle.

2. The computer-implemented method of claim 1, wherein:
the updated adaptive filters are associated with a plurality of channels, wherein each of the plurality of channels corresponds to a combination of a reference signal of a respective channel of the plurality of channels and a noise control signal of the respective channel of the plurality of channels;
the transmitting comprises transmitting, via one or more packets, each of the updated adaptive filters;
each of the one or more packets comprises one or more chunks; and
two or more adaptive filters, of the updated adaptive filters, corresponding to different channels are put in different chunks of a single packet of the one or more packets or put in different packets of the one or more packets.

3. The computer-implemented method of claim 2, wherein each of the one or more chunks comprises:
at least one of coefficients of a respective adaptive filter, of the updated adaptive filters, corresponding to a certain channel of the plurality of channels, and channel information of the certain channel.

4. The computer-implemented method of claim 3, wherein:
the channel information comprises an identifier assigned to distinguish the certain channel from other channels of the plurality of channels; and
the channel information precedes the at least one of coefficients of the respective adaptive filter in each respective chunk of the one or more chunks.

5. The computer-implemented method of claim 1, wherein:
each local signal, of the one or more local signals, is a multi-channel signal associated with a plurality of channels; and
the receiving the one or more local signals comprises:
parsing one or more packets received from the vehicle; and
extracting, based on the parsed one or more packets, samples for each channel of each local signal of the one or more local signals.

6. The computer-implemented method of claim 5, wherein:
each of the one or more packets comprises one or more chunks; and
each of the one or more chunks comprises:
at least one of samples corresponding to a combination of a certain local signal of the one or more local signals and a certain channel of the plurality of channels, and
channel information of the combination of the certain local signal and the certain channel.

7. The computer-implemented method of claim 6, wherein:
the channel information comprises an identifier assigned to distinguish the certain local signal from other local signals of the one or more local signals and distinguish the certain channel from other channels of the plurality of channels of the certain local signal; and
the channel information precedes the at least one of samples in each respective chunk of the one or more chunks.

8. The computer-implemented method of claim 2, wherein:
each of the one or more packets further comprises an indication of a data dimension of the one or more chunks; and
the indication of the data dimension precedes the one or more chunks in each respective packet of the one or more packets.

9. The computer-implemented method of claim 8, wherein:
each of the one or more packets further comprises at least one of a time index or ANC control status information; and
the at least one of the time index or the ANC control status information precedes the indication of the data dimension in each respective packet of the one or more packets.

10. A method performed in a vehicle associated with a remote active noise control (ANC) system, the method comprising:
transmitting, to a server associated with the ANC system, one or more local signals, wherein the one or more local signals are associated with noise control by an ANC controller of the vehicle, and wherein each local signal, of the one or more local signals, comprises a reference signal, a noise control signal, an error signal, or a virtual error signal;
receiving, from the server, adaptive filters of the remote ANC system, wherein the adaptive filters are updated based on the one or more local signals; and
generating, by the ANC controller, a noise control signal by applying the received adaptive filters to the reference signal.

11. The method of claim 10, wherein:
each local signal, of the one or more local signals, is a multi-channel signal associated with a plurality of channels, and
the transmitting the one or more local signals comprises transmitting, to the server via one or more packets, samples for each channel of each local signal of the one or more local signals;
each of the one or more packets comprises one or more chunks; and
two or more samples, of the samples, corresponding to different channels are put in different chunks of a single packet or put in different packets of the one or more packets.

12. The method of claim 11, wherein each of the one or more chunks comprises channel information of a combination of a certain local signal of the one or more local signals and a certain channel of the plurality of channels, and wherein at least one of samples corresponds to the combination.

13. The method of claim 12, wherein:
the channel information comprises an identifier assigned to distinguish the certain local signal from other local signals of the one or more local signals and distinguish the certain channel from other channels of the plurality of channels of the certain local signal; and
the channel information precedes the at least one of samples in each respective chunk of the one or more chunk.

14. The method of claim 10, wherein:
the received adaptive filters are associated with a plurality of channels, wherein each of the plurality of channels corresponds to a combination of a reference signal of a respective channel of the plurality of channels and a noise control signal of the respective channel of the plurality of channels; and
the receiving the adaptive filters comprises:
parsing one or more packets received from the server; and
extracting, based on the parsed one or more packets, each of the received adaptive filters corresponding to a respective channel of the plurality of channels.

15. The method of claim 14, wherein:
each of the one or more packets comprises one or more chunks; and
each of the one or more chunks comprises:
at least one of coefficients of a respective adaptive filter, of the adaptive filters, corresponding to a certain channel of the plurality of channels, and
channel information of the certain channel.

16. The method of claim 15, wherein:
the channel information comprises an identifier assigned to distinguish the certain channel from other channels of the plurality of channels; and
the channel information precedes the at least one of coefficients of the respective adaptive filter in each respective chunk of the one or more chunks.

17. The method of claim 11, wherein:
each of the one or more packets further comprises an indication of a data dimension of the one or more chunks; and
the indication of the data dimension precedes the one or more chunks in each respective packet of the one or more packets.

18. The method of claim 17, wherein:
each of the one or more packets further comprises at least one of a time index or ANC control status information; and
the at least one of the time index or the ANC control status information precedes the indication of the data dimension in each respective packet of the one or more packets.

19. A device for updating an adaptive filter in a remote active noise control (ANC) system, the device comprising:
a memory storing instructions; and
at least one processor configured to execute the instructions to cause the device to:
receive one or more local signals from a vehicle, wherein the one or more local signals are associated with noise control by an ANC controller of the vehicle, and wherein each local signal, of the one or more local signals, comprises a reference signal, a noise control signal, an error signal, or a virtual error signal,
update, using the one or more local signals, the adaptive filter of the remote ANC system, and
transmit, to the vehicle, the updated adaptive filter to adjust the ANC controller of the vehicle.

20. A device included in a vehicle in a remote active noise control (ANC) system, the device comprising:
a memory storing instructions; and
at least one processor configured to execute the instructions to cause the device to perform the method of claim 10.
